(19) United States
(12) Patent Application Publication
(10) Pub. No.: US 2023/0112114 A1
(43) Pub. Date: Apr. 13, 2023

(54) METHODS AND SYSTEMS TO REDUCE AUTO-FLUORESCENCE IN FLUORESCING SAMPLES

(71) Applicant: Applied Materials, Inc., Santa Clara, CA (US)

(72) Inventors: Joseph R. Johnson, Redwood City, CA (US); Yang Ming Lee, Singapore (SG); Hsiao-Ying Cheng, Singapore (SG); Christabelle Si Mei Goh, Singapore (SG); Ustun Serdar Tulu, Los Altos, CA (US); Chang H. Choi, San Jose, CA (US); Chloe Kim, Mountain View, CA (US)

(73) Assignee: Applied Materials, Inc., Santa Clara, CA (US)

(21) Appl. No.: 17/953,575

(22) Filed: Sep. 27, 2022

Related U.S. Application Data
(60) Provisional application No. 63/253,340, filed on Oct. 7, 2021.

(51) Int. Cl. G01N 1/34; G01N 1/44; G01N 21/64

(52) U.S. Cl. CPC G01N 1/34; G01N 1/44; G01N 21/6428; G01N 2021/6439

(57) ABSTRACT

Exemplary sample processing methods are described that include providing an initial sample to a sample processing system. The sample processing system includes a light-emitting-diode, a temperature control unit, and a fluid supply unit. The methods also include irradiating the initial sample with light emitted from the light-emitting-diode to produce an irradiated sample. The methods may still further include adjusting a temperature of the irradiated sample with the temperature control unit to between 0° C. and 60° C., and contacting the irradiated sample with a fluid from the fluid supply unit. The irradiated sample has a reduction in auto-fluorescence of greater than or about 50% compared to the initial sample. Exemplary sample processing systems are also described that include a light-emitting-diode, a temperature control unit, and a fluid supply unit.

### CROSS-REFERENCE TO RELATED APPLICATIONS

This application claims the benefit of, and priority to U.S. Provisional Application Ser. No. 63/253,340, filed Oct. 7, 2021, which is hereby incorporated by reference in its entirety for all purposes.

### TECHNICAL FIELD

The present technology relates to methods and systems to reduce auto-fluorescence in fluorescing samples. More specifically, the present technology relates to methods and systems to photobleach endogenous auto-fluorescing compounds in biological samples with light-emitting-diodes.

### BACKGROUND

Fluorescence technology is used to identify and characterize the spatial distribution of a variety of compounds in biological samples. In some instances, the compounds themselves emit a fluorescence signature permitting the identification and characterization of the compound in the sample. These compounds are said to auto-fluoresce. In other instances, an exogenous fluorescing compound binds to a target compound of interest, and fluorescence from the exogenous compound acts as a proxy for the identification and characterization of the target compound.

In many cases, biological samples include one or more endogenous auto-fluorescent compounds that create background fluorescence which interferes with the detection of the fluorescence associated with the target compound. In some cases, this background autofluorescence from the endogenous auto-fluorescent compounds in the sample can significantly reduce the signal-to-noise ratio while trying to detect the fluorescence associated with the target compound. In additional cases, the background autofluorescence can be so intense as to prevent the detection and characterization of the fluorescence associated with the target compound. Thus, there is a need for improved methods and systems that reduce background autofluorescence from endogenous compounds in the sample to permit improved detection of the fluorescence associated with one or more target compounds.

### SUMMARY

Embodiments of the present technology include sample processing methods that include providing an initial sample to a sample processing system. The sample processing system includes a light-emitting-diode, a temperature control unit, and a fluid supply unit. The methods also include irradiating the initial sample with light emitted from the light-emitting-diode to produce an irradiated sample. The methods may still further include adjusting a temperature of the irradiated sample with the temperature control unit to between 0° C. and 60° C., and contacting the irradiated sample with a fluid from the fluid supply unit. The irradiated sample has a reduction in auto-fluorescence of greater than or about 50% compared to the initial sample.

In additional embodiments, the initial sample is a biological sample that includes one or more auto-fluorescing compounds. In further embodiments, the irradiated sample is adjusted to a temperature between 30° C. and 40° C. In still further embodiments, the irradiated sample is contacted with a fluid selected from the group consisting of water, an alcohol, and an aldehyde. In yet additional embodiments, the light-emitting-diode is characterized by a power density of greater than or about 100 mW/cm². In more embodiments, the light-emitting-diode is characterized by a color temperature of greater than or about 2200K. In yet more embodiments, the irradiated sample is irradiated for less than or about 2 hours. In still additional embodiments, the irradiated sample is characterized by an irradiation area of greater than or about 5 cm².

Embodiments of the present technology also include sample processing methods that include providing an initial sample to a sample processing system, wherein the initial sample comprises at least one exogenous fluorescent compound and at least one endogenous autofluorescent compound. The methods also include irradiating the initial sample with light from a light-emitting-diode to produce an irradiated sample. The irradiated sample is characterized by a reduction in auto-fluorescence from the endogenous autofluorescent compound of greater than or about 50% compared to the initial sample. The methods further include measuring a fluorescence emission from the at least one exogenous fluorescent compound in the irradiated sample before photobleaching the irradiated sample with laser light.

In additional embodiments, the sample processing methods further include adjusting a temperature of the irradiated sample to between 0° C. and 60° C. In further embodiments, the methods further include contacting the irradiated sample with a fluid selected from the group consisting of water, an alcohol, and an aldehyde. In still further embodiments, the irradiated sample is irradiated for less than or about 2 hours. In yet additional embodiments, the light-emitting-diode is characterized by a power density of greater than or about 100 mW/cm². In more embodiments, the light-emitting-diode is characterized by a color temperature of greater than or about 2200K.

Embodiments of the present technology further include sample processing systems that include a light-emitting-diode operable to irradiate an initial sample to make an irradiated sample. The systems further include a temperature control unit operable to adjust a temperature of the irradiated sample to between 0° C. and 60° C., and a fluid supply unit operable to supply a fluid to the irradiated sample. The fluid may be selected from the group consisting of water, an alcohol, and an aldehyde.

In additional embodiments, the light-emitting-diode is operable to emit light characterized by wavelengths of 400 nm to 750 nm. In further embodiments, the light-emitting-diode is operable to emit light characterized by a power density of greater than or about 100 mW/cm². In still further embodiments, the light-emitting-diode is operable to emit light characterized by a color temperature of greater than or about 2200K. In yet additional embodiments, the system is operable to cool the irradiated sample to between 0° C. and 60° C., and heat the irradiated sample to between 30° C. and 40° C. In more embodiments, the system is operable to irradiate initial samples with an irradiation area of greater than or about 1 cm².

Embodiments of the present technology provide improved detection and imaging of exogenous fluorescent compounds in samples that include one or more endogenous autofluorescent compounds. In embodiments, the light-emitting-diodes irradiate the sample to photobleach at least a portion of the endogenous autofluorescent compounds so that they do not fluoresce during the detection and imaging of the one or more exogenous fluorescent compounds. The decrease of fluorescence from the endogenous autofluorescent compounds increases a signal-to-noise ratio of fluorescent light emitted from the exogenous fluorescent compounds, which improves both the detection limits and image quality of the fluorescing exogenous compounds in the sample. These and other embodiments, along with many of their advantages and features, are described in more detail in conjunction with the below description and attached figures.

### BRIEF DESCRIPTION OF THE DRAWINGS

A further understanding of the nature and advantages of the disclosed embodiments may be realized by reference to the remaining portions of the specification and the drawings.

FIG. 1A shows a sample preparation system according to some embodiments of the present technology.

FIG. 1B shows another embodiment of a sample preparation system according to some embodiments of the present technology.

FIG. 1C shows a sample array and sample substrate operable to be held in a sample preparation system according to some embodiments of the present technology.

FIG. 2 shows a flowchart with selected operations in a sample preparation method according to embodiments of the present technology.

Several of the figures are included as schematics. It is to be understood that the figures are for illustrative purposes and are not to be considered of scale unless specifically stated to be of scale. Additionally, as schematics, the figures are provided to aid comprehension and may not include all aspects or information compared to realistic representations and may include exaggerated material for illustrative purposes.

In the figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

Fluorescence microscopy is used to identify and spatially characterize a variety of compounds in biological samples. For example, fluorescence microscopy can be used to identify and characterize specific proteins and nucleic acid sequences in biological tissue samples, such as brain tissue samples. The proteins of interest may be targeted by exogenous fluorescing compounds that only bind to the proteins of interest. When the unbound exogenous fluorescing compounds are removed from the sample, the bound fluorescing compounds act as a proxy to identify the proteins and nucleic acid sequences of interest and characterize their spatial distribution in the sample. These identifications and characterizations of proteins, nucleic acid sequences, and other compounds of interest in biological samples make fluorescence microscopy a valuable tool to understand the composition, structure, and genetics of biological samples.

Unfortunately, many types of biological samples also include endogenous compounds that can autofluoresce at overlapping wavelengths with the exogenous fluorescing compounds used to identify and characterize compounds of interest. For example, many types of brain tissue samples include lipofuscin (an age pigment), elastin, and collagen, which generate background autofluorescence which can reduce the signal-to-noise ratio from the exogenous fluorescing compounds in the sample. Additional autofluorescing compounds may be introduced by compounds used to prepare the tissue sample for fluorescence microscopy. In some instances, the endogenous and added autofluorescing compounds can completely mask the signal from the exogenous fluorescing compounds.

Conventional methods to reduce unwanted autofluorescence include chemical quenchers that suppress the fluorescence from endogenous compounds. Unfortunately, many chemical quenchers also suppress fluorescence from the exogenous fluorescing compounds used to identify and characterize compounds of interest. This results in fluorescence microscopy measurements with poor signal-to-noise ratios as the fluorescence signal from the exogenous compounds is reduced along with the background fluorescence noise from the endogenous compounds. In addition, many chemical quenchers can alter the biological sample in ways that give a false characterization of the compounds of interest in the sample. The chemical quenchers are also an expensive and time-consuming addition to the preparation of the biological sample.

Additional conventional methods include photobleaching the endogenous autofluorescing compounds with a laser that is tuned to a wavelength that reduces or stops the compounds from fluorescing. These laser photobleaching operations include irradiating a portion of the sample with a high-intensity, monochromatic beam of laser light for a period that typically lasts 30 seconds to a minute or more. The beam of laser light typically has a circular cross-section with a diameter less than or about 500 μm. The small cross-sectional area of the beam often requires multiple irradiation cycles to traverse the entire area of a sample or an array of samples. For example, a region of interest that includes a 10×10 array of 500 μm spots, each of which is irradiated by the laser beam for one minute, requires 100 minutes to photobleach the entire sample array. When more than one wavelength of laser light is needed for effective photobleaching, the array may need to be irradiated for a second, third, or more times, which can result in the photobleaching operation taking several hours to complete.

The present technology irradiates a sample with light from at least one light-emitting-diode (LED) that covers a wider area and larger range of wavelengths than a photobleaching laser. The light emitted from the LED can photobleach one or more autofluorescent compounds in the sample that can interfere with the detection of a fluorescence signal from an exogenous fluorescent compound incorporated into the sample. The LED photobleaching reduces or eliminates the need to laser photobleach the sample, and can also eliminate the need to introduce chemical quenchers to the sample.

In embodiments, sample processing systems according to the present technology incorporate one or more LEDs for sample photobleaching. In additional embodiments, the sample processing systems can include a temperature control unit that is operable to adjust the temperature of the sample to both below room temperature (e.g., about 0° C. to about 20° C.) and above room temperature (e.g., about 30° C. to about 40° C.). This permits several sample preparation operations to take place in the sample processing system at different temperatures. For example, a tissue sample can remain in the system while being pretreated with a fixation solution at less than room temperature (e.g., 1° C. to 10° C.), and also while being dyed with a solution containing one or more exogenous fluorescent compounds at greater than room temperature (e.g., 30° C. to 40° C.). In additional embodiments, the LEDs may be irradiating the sample during one or both of the pretreatment and dying operations.

In further embodiments, the sample processing systems can include a fluid supply unit that is operable to supply one or more fluids to the sample. In embodiments, the fluids supplied by the fluid supply unit may include fixation fluids, photobleaching fluids, fluorescent dye fluids, blocking fluids, antibody fluids, and mounting fluids, among other kinds of fluids. In some embodiments, the temperature of the supplied fluid may be the same as the sample (e.g., room temperature). In additional embodiments, the temperature of the fluid and the sample may be different, and the fluid assists in adjusting the temperature of the sample. In still further embodiments, the temperature of the supplied fluid may be greater than the temperature of the sample, and the supplied fluid assists in increasing the temperature of the sample in contact with the fluid. In more embodiments, the LEDs in the sample processing system may be irradiating the sample during contact with the fluid from the fluid supply unit. By irradiating the sample in the sample processing system during one or more sample preparation steps, less time is needed for a subsequent LED photobleaching operation. In some embodiments, the photobleaching operation may be completed at the same time as the other sample preparation operations, and no subsequent LED photobleaching operation is performed.

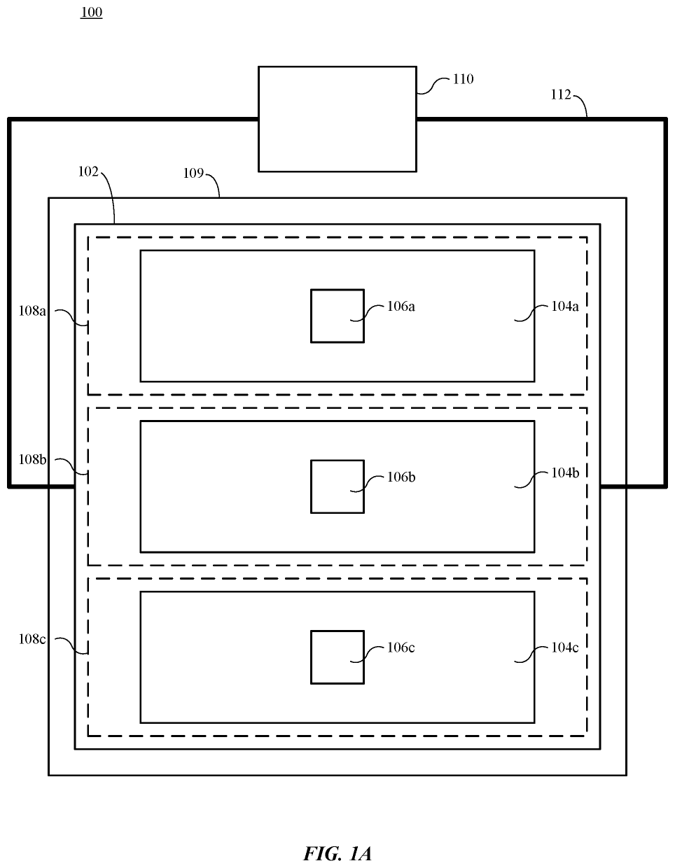

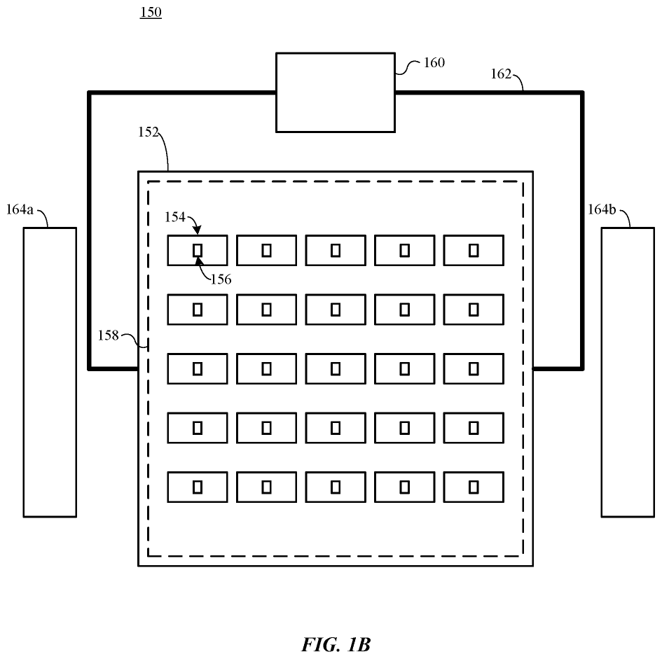

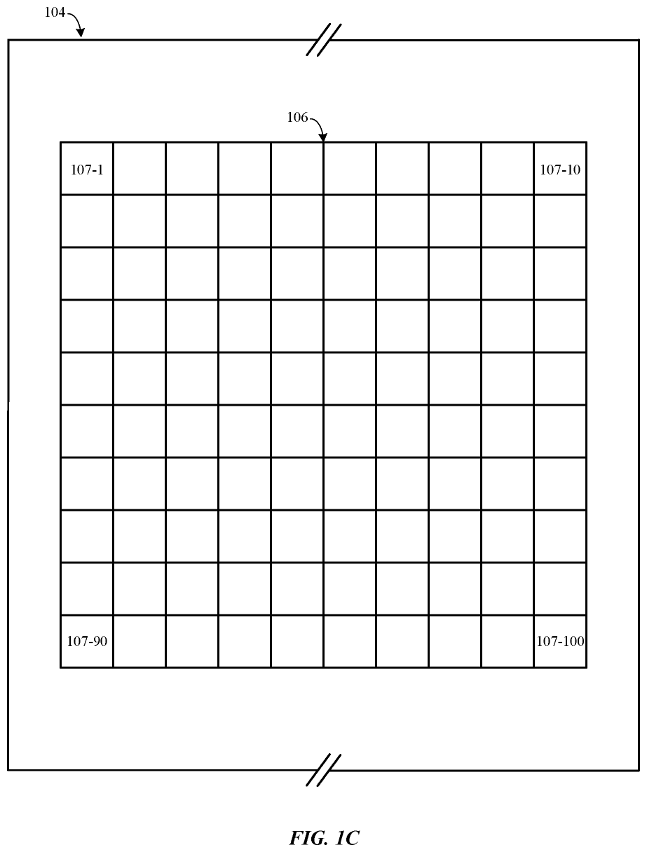

FIG. 1A shows an embodiment of a sample preparation system 100 that can perform sample preparation methods according to embodiments of the present technology. The system 100 includes an array of LED lights 108a-c that are operable to irradiate samples that are placed in the system. In the embodiment shown, the LED lights 108a-c are positioned below the sample substrates 104a-c that support samples 106a-c. Also, in the embodiment shown, each LED light 108a-c may be an individual LED lamp, or a panel array LED element positioned under one of the sample substrates 104a-c. In further embodiments, the sample substrates 104a-c are made of materials that permit light emitted from the LED lights 108a-c to pass through the sample substrates and irradiate the samples 106a-c supported on the sample substrates. In additional embodiments, the sample substrate may be glass slides that can transmit visible light (e.g., light having wavelengths of 400 nm to 750 nm). In more embodiments (not shown), the LED lights 108a-c may be posited above the samples 106a-c.

In embodiments, the LED lights 108a-c may include phosphor-containing LEDs that emit a broad spectrum of polychromatic light (i.e., white light) from phosphor materials that are irradiated with narrow-spectrum light directly from one or more LEDs. In further embodiments, these phosphor-containing LEDs may include at least one of cerium-doped yttrium-aluminum-garnet (Ce:YAG) phosphors and manganese (IV)-doped potassium fluorosilicate (PFS) phosphors, among other types of phosphors. The phosphors may be irradiated by one or more LEDs that emit a narrower spectrum of light. In embodiments, these LEDs may include indium-gallium-nitride (InGaN)-containing LEDs that are operable to emit light with a peak intensity that is blue-shifted from the light emitted by the phosphors. In yet more embodiments, the InGaN-containing LEDs may be operable to emit light characterized by a narrow emission spectrum (e.g., FWHM of less than or about 50 nm) and blue-shifted peak (e.g., less than or about 475 nm, less than or about 450 nm, or less). In further embodiments, the narrow-spectrum, blue-shifted InGaN LEDs excite nearby phosphors to emit broader-spectrum light characterized by an FWHM of greater than or about 100 nm and a peak emission wavelength greater than or about 500 nm. In additional embodiments, the LED lights 108a-c may include combinations of red, green, and blue LEDs that combined emit broad-spectrum white light. In embodiments, the red, green, and blue LEDs may include inorganic materials such as InGaN or may include organic materials (e.g., OLEDs).

In embodiments, the white light emitted by the LED lights 108a-c may be characterized by a color temperature. White light emitted with a higher color temperature is characterized by a bluer hue, while white light emitted with a lower color temperature is characterized by a more orange-red hue. In additional embodiments, the white light emitted by the LED lights 108a-c may be characterized by a color temperature of greater than or about 2000K, greater than or about 2200K, greater than or about 2500K, greater than or about 3000K, greater than or about 3500K, greater than or about 4000K, greater than or about 4500K, greater than or about 5000K, or more.

In further embodiments, the LED lights 108a-c may be tunable to emit a narrower spectrum of light centered on a peak emission wavelength. In additional embodiments, the narrower spectrum of the tunable emitted light may be characterized by a full-with-half-maximum (FWHM) value of less than or about 150 nm, less than or about 125 nm, less than or about 100 nm, less than or about 75 nm, less than or about 50 nm, or less. In more embodiments, the tunable emitted light may be characterized by a peak emission wavelength of 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, or 750 nm, among other peak emission wavelengths. In embodiments, a narrower-spectrum, tunable LED light may be used to photobleach a target endogenous autofluorescent compound in the sample. In further embodiments, a combination of tunable LED light and white LED light may be used to photobleach a sample that contains one or more target autofluorescent compounds that are characterized by a high cross-section of absorbance at the tunable light's peak emission wavelength and also contains additional autofluorescent compounds that can be photobleached by the white LED light. In still further embodiments, the photobleaching operations may include one or more cycles of sequential exposure of the sample to the white LED light during one period of irradiation and the tunable LED light during another period of irradiation. In yet further embodiments, the photobleaching operations may include one or more cycles of sequential exposure of the sample to tunable LED light at different peak intensity wavelengths.

In embodiments, the LED lights 108a-c may irradiate samples in system 100 at a constant power density. In further embodiments, the LED lights 108a-c may be characterized by a power density of greater than or about 50 mW/cm², greater than or about 100 mW/cm², greater than or about 150 mW/cm², greater than or about 200 mW/cm², greater than or about 250 mW/cm², greater than or about 300 mW/cm², greater than or about 350 mW/cm², greater than or about 400 mW/cm², greater than or about 450 mW/cm², greater than or about 500 mW/cm², greater than or about 550 mW/cm², greater than or about 600 mW/cm², greater than or about 650 mW/cm², greater than or about 700 mW/cm², greater than or about 750 mW/cm², greater than or about 1000 mW/cm², or more. In more embodiments, the LED lights 108a-c may be characterized by a larger and more diffuse irradiation area than seen with a focused beam of laser light. In embodiments, the LED lights 108a-c may have a power density of less than or about 1 W/cm².

In yet more embodiments, the LED lights 108a-c may irradiate samples in system 100 at a variable power density. In embodiments, the LED lights 108a-c may irradiate the samples at a first power density during a first sample preparation operation and a second power density during a second sample preparation operation. In further embodiments, the first sample preparation operation may be sample fixation operation when the samples 106a-c are in contact with a fixation fluid supplied to the sample holder 102 by the fluid supply unit 110. The first power density may be a lower power density characterized at less than 100 mW/cm². In additional embodiments, the second sample preparation operation may be a dying operation when the samples 106a-c are in contact with a dying fluid containing one or more exogenous fluorescent compounds. The second power density may be a higher power density characterized at greater than or about 100 mW/cm². In more embodiments, the power density of the LED lights 108a-c may be adjusted by continuously increasing and decreasing the amount of electrical power supplied to the LED lights. In yet more embodiments, the power density of the LED lights 108a-c may be adjusted by turning on and off a portion of the LEDs in the LED lights.

The system 100 may further include a temperature control unit 109 that is operable to adjust the temperature of the samples during at least a portion of the sample preparation method. In embodiments, the temperature control unit 109 may include a surface that is operable to be adjusted to a temperature below room temperature during low-temperature sample preparation operations. In additional embodiments, the same surface of the temperature control unit 109 may be adjusted to a temperature above room temperature during high-temperature sample preparation operations. In further embodiments, the temperature control unit 109 may include conduits (not shown) for the flow of a temperature control fluid that adjusts the temperature of the surface to a target temperature. In more embodiments, the temperature control unit 109 may include electric heating and cooling elements (not shown) that adjust the temperature of the surface to a target temperature.

In embodiments, before or during a low-temperature operation, the temperature control unit 109 may be operable to adjust the temperature of one or more samples placed in the system 100 to less than 25° C., less than or about 20° C., less than or about 15° C., less than or about 10° C., less than or about 8° C., less than or about 6° C., less than or about 4° C., less than or about 2° C., less than or about 1° C., or less. In embodiments, the temperature control unit 109 may be operable to adjust the temperature of one or more samples in the system 100 to greater than 0° C. in order to keep the sample from freezing during a low-temperature operation. In yet further embodiments, during a high-temperature operation, the temperature control unit may be operable to adjust the temperature of one or more samples placed in the system 100 to greater than 25° C., greater than or about 28.5° C., greater than or about 30° C., greater than or about 32.5° C., greater than or about 35° C., greater than or about 37.5° C., greater than or about 40° C., greater than or about 45° C., greater than or about 50° C., greater than or about 55° C., greater than or about 60° C., greater than or about 65° C., greater than or about 70° C., greater than or about 75° C., or more.

The system 100 may still further include a fluid supply unit 110 that is operable to supply fluid to a sample holder 102 that can hold one or more sample substrates 104a-c upon which samples 106a-c are placed. In embodiments, the fluid supply unit 110 may include a fluid transport conduit 112 that is operable to deliver fluid from the fluid supply unit to the fluid sample holder 102. In further embodiments, the fluid transport conduit 112 may also be operable to remove fluid from the sample holder 102 and return it to the fluid supply unit. In other embodiments, the fluid transport conduit 112 may remove fluid from the sample holder 102 and send it to a recycling unit or waste disposal unit (not shown) instead of back to the fluid supply unit 110.

In the embodiments shown in FIG. 1A, the fluid supply unit 110 supplies fluid to the samples 106a-c from a single fluid transport conduit 112 in fluid connection with the sample holder 102. In additional embodiments, the fluid supply unit 110 may include two or more fluid transport conduits that each supply fluid to a subset of the samples in system 100. In further embodiments, each of the fluid transport conduits may transport a fluid characterized by one or more differences from the fluids transported by other fluid transport conduits. These differences may include the fluid's temperature, the concentration of one or more compounds, pH, and viscosity, among other differences.

In additional embodiments, the fluid supply unit 110 may be operable to supply one or more types of fluids, including water, one or more alcohols, and one or more aldehydes, among other types of fluids. In embodiments, the alcohols may include methanol, ethanol, and isopropyl alcohol, among other types of alcohols. In further embodiments, the aldehydes may include formaldehyde and acetaldehyde, among other types of aldehydes. In yet further embodiments, the fluids may act as solvents and further include dissolved compounds. In embodiments, the dissolved compounds may include inorganic salts such sodium chloride, organic salts such as sodium citrate, and acids such as hydrochloric acid, among other dissolved compounds. In still further embodiments, the fluids may include one or more exogenous fluorescent compounds that can attach to a target compound in the sample and act as a proxy for the detection of the target compound by fluorescence detection.

In more embodiments, the temperature of the fluid supplied by the fluid supply unit 110 may contribute to a temperature adjustment of the samples 106a-c. In embodiments, where the fluid increases the temperature of the samples 106a-c, the fluid supplied by the fluid supply unit 110 may be characterized by a temperature greater than or about 30° C., greater than or about 32.5° C., greater than or about 35° C., greater than or about 37.5° C., greater than or about 40° C., greater than or about 45° C., greater than or about 50° C., greater than or about 55° C., greater than or about 60° C., or more. In additional embodiments, where the fluid decreases the temperature of the samples 106a-c, the fluid supplied by the fluid supply unit 110 may be characterized by a temperature less than 25° C., less than or about 20° C., less than or about 15° C., less than or about 10° C., less than or about 5° C., less than or about 1° C., or less.

FIG. 1B shows an additional embodiment of a fluid preparation system 150 according to embodiments of the present technology. System 150 includes fans 164a-b to adjust the temperature of samples 156 placed in the system. In embodiments, the fans 164a-b may be operable to provide air to the samples 156 at room temperature and temperatures other than room temperature. In further embodiments, the fans 164a-b may be operable to provide heated air to the samples 156 to adjust their temperature higher and may also be operable to provide chilled air to the samples to adjust their temperature lower.

In additional embodiments, the system 150 includes a single LED light 158 under the sample holder 152. In these embodiments, the sample holder 152 and the sample substrates 154 are made of materials that permit the passage of visible light, e.g., translucent plastic, glass, etc. The LED light 158 may include one or more LEDs that emit light to photobleach the samples 156.

In further embodiments, the system 150 includes a fluid supply unit 160 to supply fluid to the samples 156 in the sample holder 152 from the fluid transport conduit 162. In embodiments, the fluid transport conduit 162 may include a supply portion that supplies fluid to the sample holder 152 and a return portion that removes fluid from the sample holder. The supply and return portions of the fluid transport conduit 162 may be used to circulate fluid over the samples 156 during a sample preparation operation.

FIG. 1C shows an embodiment of a single sample 106 positioned on sample substrate 104 according to embodiments of the present technology. In an embodiment of the present technology, the sample 106 may be divided into a 10×10 array of subsamples 107-1 to 107-100. In additional embodiments (not shown), the one or more samples may be arranged on the sample substrate in a variety of square arrays, such as a 2×2 array, a 3×3 array, a 4×4 array, a 5×5 array, a 6×6 array, a 7×7 array, an 8×8 array, a 9×9 array, and arrays with even greater numbers of rows and columns. In more embodiments, the arrays may have an unequal number of rows and columns, such as 10×5 array or 4×6 array, among other unequal arrays. In further embodiments, each of the subsamples 107-1 to 107-100 may be characterized by an area on the sample substrate 104 of greater than or about 0.25 mm², greater than or about 0.5 mm², greater than or about 0.75 mm², greater than or about 1 mm², or more. In still further embodiments, the sample 106 may be characterized by an area of greater than or about 0.25 cm², greater than or about 0.5 cm², greater than or about 0.75 cm², greater than or about 1 cm², or more. In more embodiments, the sample substrate may be a glass slide that can be provided to the sample preparation system 100 for photobleaching and other sample preparation operations before being provided to a fluorescence detection system (not shown). In yet more embodiments, the surface of the glass slide in contact with the sample may be characterized by a length of greater than or about 75 mm and a width of greater than or about 25 mm. In still more embodiments, the glass slide may be characterized as having a circular shape with a diameter of greater than or about 50 mm.

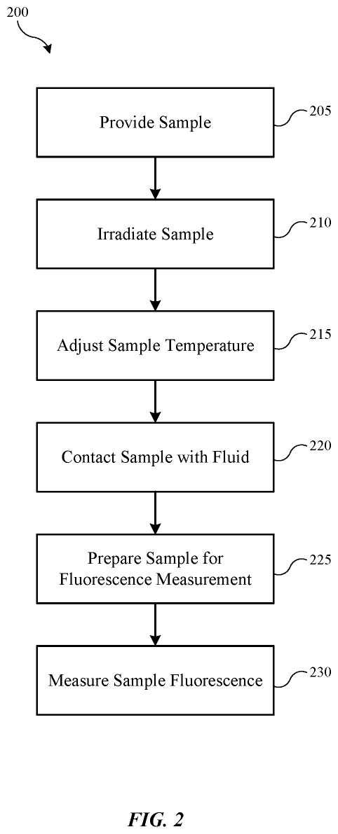

Embodiments of the above-described systems 100 and 150, shown in FIGS. 1A-B, may be used to perform embodiments of the present methods to process samples. FIG. 2 shows exemplary operations in a method 200 of processing samples according to embodiments of the present technology. The method 200 may also include one or more operations prior to the initiation of the method, including cutting samples and securing them to sample substrates or any other operations that may be performed prior to the described operations. The method may further include a number of optional operations, which may or may not be specifically associated with some embodiments of methods according to the present technology. For example, many of the operations are described in order to provide a broader scope of the processes performed but are not critical to the technology or may be performed by alternative methodology, as will be discussed further below. It is to be understood that the figures illustrate only partial schematic views, and the systems and methods may contain any number of additional components and operations having a variety of characteristics and aspects.

Embodiments of method 200 include providing a sample to a sample processing system at operation 205. The provided sample may include one or more endogenous autofluorescent compounds and one or more compounds that can be targeted by exogenous fluorescent compounds. In embodiments, the sample may be a biological sample. In further embodiments, the biological sample may be a biological tissue sample taken from a plant or animal. In still further embodiments, the biological tissue sample may include a brain tissue sample, a heart tissue sample, a bone tissue sample, a liver tissue sample, a kidney tissue sample, an eye tissue sample, a skin tissue sample, among other kinds of biological tissue samples.

In embodiments, the sample may be mounted on a sample substrate. In further embodiments, the contact area between the sample and the sample substrate may be greater than or about greater than or about 0.25 mm², greater than or about 0.5 mm², greater than or about 0.75 mm², greater than or about 1 mm², or more. In additional embodiments, the sample may be characterized by a thickness that permits photobleaching LED light to penetrate through the sample. In embodiments, the sample may be characterized by a thickness of less than or about 1000 μm, less than or about 500 μm, less than or about 250 μm, less than or about 100 μm, less than or about 75 μm, less than or about 50 μm, less than or about 25 μm, or less.

In additional embodiments, the sample mounted on the sample substrate may be placed in a sample holder that may be positioned above one or more LED lights in the system. In embodiments, a single sample may be placed in the sample holder. In further embodiments, multiple samples may be placed in the sample holder, such as greater than or about two samples, greater than or about three samples, greater than or about four samples, greater than or about five samples, greater than or about eight samples, greater than or about ten samples, greater than or about fifteen samples, greater than or about twenty samples, greater than or about thirty samples, greater than or about forty samples, greater than or about fifty samples, greater than or about sixty samples, greater than or about seventy samples, greater than or about eighty samples, greater than or about ninety samples, greater than or about one hundred samples, or more.

Embodiments of method 200 may further include irradiating one or more samples in the sample processing system at operation 210. In embodiments, the samples are irradiated with one or more LED lights that emit light over an area covering the contact area of the samples on the sample substrates. The LED light may photobleach the samples by partially or fully inactivating the autofluorescence from one or more endogenous autofluorescent compounds in the samples.

In embodiments, the irradiation operation 210 may reduce the intensity of autofluorescence from the sample by greater than or about 10%, greater than or about 20%, greater than or about 30%, greater than or about 40%, greater than or about 50%, greater than or about 60%, greater than or about 70%, greater than or about 80%, greater than or about 90%, or more.

In embodiments, the reduction in the intensity of autofluorescence from a sample may be correlated with the irradiation time. The longer the irradiation time, the larger the reduction in autofluorescence from the photobleaching operation. In additional embodiments, the irradiation of the samples by the LED lights may start soon after the samples are provided to the sample preparation system and may continue through one or more additional sample processing operations, including sample fixing operations, sample dying operations, sample blocking operations, sample antibody introduction operations, and sample mounting operations, among other sample processing operations. In yet additional embodiments, the LED lights may irradiate the samples for greater than or about 0.5 hours, greater than or about 0.75 hours, greater than or about 1 hour, greater than or about 1.25 hours, greater than or about 1.5 hours, greater than or about 1.75 hours, greater than or about 2 hours, greater than or about 2.25 hours, greater than or about 2.5 hours, greater than or about 2.75 hours, greater than or about 3 hours, or more. In still more embodiments, the irradiation operation may proceed while the samples are being stored and awaiting fluorescence measurements. In embodiments, these irradiation times during the storage period may be greater than or about 8 hours, greater than or about 10 hours, greater than or about 12 hours, greater than or about 24 hours, greater than or about 48 hours, or more.

In further embodiments, the LED lights irradiate the samples with light characterized by a power density of greater than or about 50 mW/cm², greater than or about 100 mW/cm², greater than or about 150 mW/cm², greater than or about 200 mW/cm², greater than or about 250 mW/cm², greater than or about 300 mW/cm², greater than or about 350 mW/cm², greater than or about 400 mW/cm², greater than or about 450 mW/cm², greater than or about 500 mW/cm², greater than or about 550 mW/cm², greater than or about 600 mW/cm², greater than or about 650 mW/cm², greater than or about 700 mW/cm², greater than or about 750 mW/cm², greater than or about 1000 mW/cm², or more. In more embodiments, the LED lights may irradiate the samples with white light characterized by a color temperature of greater than or about 2000K, greater than or about 2200K, greater than or about 2500K, greater than or about 3000K, greater than or about 3500K, greater than or about 4000K, greater than or about 4500K, greater than or about 5000K, or more. In still more embodiments, the LED lights may irradiate the samples with narrower-spectrum light that may be characterized as a red color, a green color, or a blue color, among other colors.

Embodiments of method 200 further include adjusting the temperature of the samples in the sample processing system at operation 215. In embodiments, this temperature adjustment may be made with a temperature control unit in thermal communication with the samples in the sample processing system. The temperature control unit may be operable to adjust the temperature of the samples to less than room temperature or greater than room temperature depending on the sample preparation operation. In embodiments, the temperature adjustment operation may include adjusting the sample temperature to less than room temperature while the sample is in contact with a fixing fluid and during a photobleaching operation. In additional embodiments, the same sample may be adjusted to a sample temperature greater than room temperature while the sample is in contact with a dying fluid. In embodiments, the temperature adjustment operation 215 may include two or more sample temperature adjustments as the sample is being processed in the sample processing system.

In additional embodiments, the adjustment of the sample temperature may be characterized by adjusting the sample temperature to between about 0° C. and about 60° C. In embodiments, the temperature of the sample may be adjusted to above room temperature, and the sample may be characterized by a temperature of greater than 25° C., greater than or about 28.5° C., greater than or about 30° C., greater than or about 32.5° C., greater than or about 35° C., greater than or about 37.5° C., greater than or about 40° C., greater than or about 45° C., greater than or about 50° C., greater than or about 55° C., greater than or about 60° C., greater than or about 65° C., greater than or about 70° C., greater than or about 75° C., or more. In further embodiments, the temperature of the sample may be adjusted to below room temperature, and the sample may be characterized by a temperature of less than 25° C., less than or about 20° C., less than or about 15° C., less than or about 10° C., less than or about 8° C., less than or about 6° C., less than or about 4° C., less than or about 2° C., less than or about 1° C., or less.

In still further embodiments, the temperature control unit of the sample processing system may be operable to keep the sample temperature substantially constant for the duration of a sample processing operation. In additional embodiments, the temperature control unit is operable to keep the sample temperature substantially constant for greater than or about 0.5 hours, greater than or about 1 hour, greater than or about 1.5 hours, greater than or about 2 hours, greater than or about 2.5 hours, greater than or about 3 hours, greater than or about 3.5 hours, greater than or about 4 hours, greater than or about 4.5 hours, greater than or about 5 hours, or more. In more embodiments, the temperature control unit is able to keep the variance in the temperature of the sample to less than or about 5° C., less than or about 4° C., less than or about 3° C., less than or about 2° C., less than or about 1° C., or less.

Embodiments of method 200 also further include contacting the samples in the sample processing chamber with one or more fluids at operation 220. In embodiments, the fluids may be supplied to a sample holder in which the sample is placed with a fluid supply unit. In some embodiments, the fluid supply unit includes one or more fluid transport conduits that supply fluid to the sample holder and remove fluid from the sample holder while the samples are being irradiated by one or more LED lights. In further embodiments, two or more fluids may be sequentially supplied to the sample holder during two or more different sample processing operations being conducted in the sample processing system.

In embodiments, the fluids contacting the samples may sit in a non-circulating state in the sample holder for a period of time. In further embodiments, the fluids may sit in the sample holder and contact the samples for greater than or about 5 minutes, greater than or about 10 minutes, greater than or about 30 minutes, greater than or about 60 minutes, greater than or about 90 minutes, greater than or about 120 minutes, greater than or about 240 minutes, or more. In more examples, the fluids may contact the samples in an intermittent flow regime were the fluid is replaced after greater than or about 1 minute, greater than or about 2 minutes, greater than or about 3 minutes, greater than or about 4 minutes, greater than or about 5 minutes, or more. In additional examples, the fluids contacting the samples may circulate in the sample holder

In additional embodiments, the fluids contacting the samples at operation 220 may include one or more of water, an alcohol, and an aldehyde. In further embodiments, the fluids may also include one or more compounds dissolved in the fluid, such as organic and inorganic salts, organic and inorganic acids, and one or more exogenous fluorescent compounds. For example, the fluid supplied to the sample during a photobleaching operation may include a buffered aqueous organic acid salt solution (e.g., a sodium citrate solution), ethanol, and formaldehyde. In further embodiments, the relative amounts of the aqueous solution, ethanol, and formaldehyde by be 10 wt. %, 70 wt. %, and 20 wt. %, respectively.

In yet additional embodiments, the fluids contacting the samples at operation 220 may also adjust the temperature of the samples. In embodiments, the supplied fluids may be characterized by a temperature between 0° C. and 60° C. In some embodiments, the supplied fluids have a temperature less than room temperature and decrease the temperature of the samples. In other embodiments, the supplied fluids have a temperature greater than room temperature and increase the temperature of the samples.

Embodiments of method 200 may still also include preparing the sample for a fluorescence measurement at operation 225. In embodiments, these operations may include exposing the samples to a humidified environment in the sample processing system, removing excess liquid from the samples, contacting the samples with a mounting medium, and applying a coverslip to each of the samples on the sample substrates, among other operations to prepare samples for fluorescence measurements. In some embodiments, one or more fluorescence preparation operations may be conducted while the LED lights are irradiating the samples in the sample processing system. In other embodiments, one or more fluorescence preparation operations may occur in a dark sample processing system. In still further embodiments, one or more of the fluorescence preparation operations may occur after the sample has been removed from the sample processing system.

Embodiments of method 200 also yet further include measuring the fluorescence from a sample at operation 230. In some embodiments, a fluorescence measurement may be performed while the sample is in the sample preparation system. In other embodiments, the sample on the sample substrate may be removed from the sample processing system and transferred to another system or device, such as a fluorescence microscope, to perform the fluorescence measurement. In embodiments, fluorescence measurements may include a measurement of light emitted from exogenous fluorescent compounds bound to target compounds, such as a particular protein or nucleic acid polymer, on the sample. In additional embodiments, the fluorescence measurements may include recording an image of fluorescing light emitted from at least a portion of the sample. In further embodiments, the image may show the spatial distribution of exogenous fluorescent compounds bound to target compounds in the sample.

Embodiments of the present technology permit the photobleaching of samples while additional sample processing operations may occur. The embodiments include photobleaching of samples with one or more LED lights while conducting additional sample preparation operations that include adjusting the sample temperature and contacting the sample with processing fluids. The concurrent performance of these operations eliminates the need for a dedicated photobleaching operation that can add a significant amount of time to the processing of a sample for fluorescence measurements. Photobleaching samples with LED light can also significantly reduce the complexity and expense of sample preparation compared to laser photobleaching that requires more complex and expensive lasers to irradiate the samples. The reduction in the complexity and expense of the LED-containing sample processing systems can further make them useful to irradiate the samples while they are being stored and transported to fluorescence measuring equipment such as a fluorescence microscope.

In the preceding description, for the purposes of explanation, numerous details have been set forth in order to provide an understanding of various embodiments of the present technology. It will be apparent to one skilled in the art, however, that certain embodiments may be practiced without some of these details, or with additional details. For example, other substrates that may benefit from the wetting techniques described may also be used with the present technology.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a compound” includes a plurality of such compounds, and reference to “the period of time” includes reference to one or more periods of time and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A sample processing method comprising:
providing an initial sample to a sample processing system, wherein the sample processing system comprises a light-emitting-diode, a temperature control unit, and a fluid supply unit;
irradiating the initial sample with light from the light-emitting diode to produce an irradiated sample;
adjusting a temperature of the irradiated sample with the temperature control unit to between 0° C. and 60° C.; and
contacting the irradiated sample with a fluid from the fluid supply unit,
wherein the irradiated sample has a reduction in auto-fluorescence of greater than or about 50% compared to the initial sample.

2. The sample processing method of claim 1, wherein the initial sample is a biological sample comprising one or more auto-fluorescing compounds.

3. The sample processing method of claim 1, wherein the irradiated sample is adjusted to a temperature between 30° C. and 40° C.

4. The sample processing method of claim 1, wherein the irradiated sample is contacted with a fluid selected from the group consisting of water, an alcohol, and an aldehyde.

5. The sample processing method of claim 1, wherein the light-emitting diode is characterized by a power density of greater than or about 100 mW/cm².

6. The sample processing method of claim 1, wherein the light-emitting diode is characterized by a color temperature of greater than or about 2200K.

7. The sample processing method of claim 1, wherein the irradiated sample is irradiated for less than or about 2 hours.

8. The sample processing method of claim 1, wherein the irradiated sample is characterized by an irradiation area of greater than or about 5 cm².

9. A sample processing method comprising:
providing an initial sample to a sample processing system, wherein the initial sample comprises at least one exogenous fluorescent compound and at least one endogenous autofluorescent compound;
irradiating the initial sample with light from a light-emitting diode to produce an irradiated sample, wherein the irradiated sample is characterized by a reduction in auto-fluorescence from the endogenous autofluorescent compound of greater than or about 50% compared to the initial sample; and
measuring a fluorescence emission from the at least one exogenous fluorescent compound in the irradiated sample before photobleaching the irradiated sample with laser light.

10. The sample processing method of claim 9, wherein the method further comprises adjusting a temperature of the irradiated sample to between 0° C. and 60° C.

11. The sample processing method of claim 9, wherein the method further comprises contacting the irradiated sample with a fluid selected from the group consisting of water, an alcohol, and an aldehyde.

12. The sample processing method of claim 9, wherein the irradiated sample is irradiated for less than or about 2 hours.

13. The sample processing method of claim 9, wherein the light-emitting diode is characterized by a power density of greater than or about 100 mW/cm².

14. The sample processing method of claim 9, wherein the light-emitting diode is characterized by a color temperature of greater than or about 2200K.

15. A sample processing system comprising:
a light-emitting-diode operable to irradiate an initial sample to make an irradiated sample;
a temperature control unit operable to adjust a temperature of the irradiated sample to between 0° C. and 60° C.; and
a fluid supply unit operable to supply a fluid to the irradiated sample, wherein the fluid is selected from the group consisting of water, an alcohol, and an aldehyde.

16. The sample processing system of claim 15, wherein the light-emitting diode is operable to emit light characterized by wavelengths of 400 nm to 750 nm.

17. The sample processing system of claim 15, wherein the light-emitting diode is operable to emit light characterized by a power density of greater than or about 100 mW/cm².

18. The sample processing system of claim 15, wherein the light-emitting diode is operable to emit light characterized by a color temperature of greater than or about 2200K.

19. The sample processing system of claim 15, wherein the system is operable to cool the irradiated sample to between 0° C. and 20° C., and heat the irradiated sample to between 30° C. and 40° C.

20. The sample processing system of claim 15, wherein the system is operable to irradiate initial samples with an irradiation area of greater than or about 5 cm².
